(19) United States
(12) Patent Application Publication
(10) Pub. No.: US 2003/0042299 A1
(43) Pub. Date: Mar. 6, 2003

(54) Data form for optical mark reading systems

(76) Inventor: Mark R. Swanson, Wisconsin Rapids, WI (US)

Correspondence Address: MERCHANT & GOULD PC, P.O. BOX 2903, MINNEAPOLIS, MN, 55402-0903, US

(21) Appl. No.: 09/946,800

(22) Filed: Sep. 4, 2001

(51) Int. Cl. G06F 17/00

(52) U.S. Cl. 235/375

(57) ABSTRACT

The present invention relates to a data form for use with an optical mark reading apparatus, the form including rows and columns of data marks locations, the first column comprising timing marks, the second column including a form compatibility mark and a third column including data mark locations indicating form length and type. The present invention further relates to a data form including rows and columns of data marks locations, at least two of the rows proximate the top of the form designated control rows and data marks within the control rows in a first column indicating timing marks, in a second column indicating form compatibility and in a third column indicating form length and layout. The present invention also relates to a data form including rows and columns of data marks locations, at least two of the rows proximate the top of the form designated control rows and data marks within the control rows in a first column indicating timing marks, in a second column indicating form compatibility and in a third column initiating a scanner calibration function. The present invention further relating to an optical mark reading system comprising a data form with data mark locations arranged in columns, the first column including timing marks, the second column including a form compatibility mark and a third column including a data marks relating to form length and type, and a scanner adapted to read the marks upon the form.

### FIELD OF THE INVENTION

The present invention relates to optical mark reading systems and forms for use with optical mark reading systems.

### BACKGROUND OF THE INVENTION

Known optical mark reading (OMR) systems are used to quickly and accurately grade exams, tabulate survey results and as a way of quickly providing feedback to students as part of adaptive learning systems. OMR systems may include scanners with multiple sensors arranged in an array to collect data regarding the presence and density of marks appearing on optical scan forms. The marks on these optical scan forms may be pre-printed or they may placed on the form by a user of the form. Improvements to these forms and OMR systems are desirable.

### SUMMARY OF THE INVENTION

The present invention relates to a data form for use with an optical mark reading apparatus, the form including rows and columns of data marks locations, the first column comprising timing marks, the second column including a form compatibility mark and a third column including data mark locations indicating form length and type. The present invention further relates to a data form including rows and columns of data marks locations, at least two of the rows proximate the top of the form designated control rows and data marks within the control rows in a first column indicating timing marks, in a second column indicating form compatibility and in a third column indicating form length and layout. The present invention also relates to a data form including rows and columns of data marks locations, at least two of the rows proximate the top of the form designated control rows and data marks within the control rows in a first column indicating timing marks, in a second column indicating form compatibility and in a third column initiating a scanner calibration function. The present invention further relating to an optical mark reading system comprising a data form with data mark locations arranged in columns, the first column including timing marks, the second column including a form compatibility mark and a third column including a data marks relating to form length and type, and a scanner adapted to read the marks upon the form.

A variety of advantages of the invention will be set forth in part in the description that follows, and in part will be apparent from the description, or may be learned by practicing the invention. It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of the description, illustrate several aspects of the invention and together with the description, serve to explain the principles of the invention. A brief description of the drawings is as follows:

FIG. 1 is a front perspective view of an optical mark reading system scanner according to the present invention.

FIG. 2 is a bottom view of the scanning face within the optical mark reading scanner of FIG. 1.

FIG. 3 is a view of a form for use with an optical mark reading system.

### DETAILED DESCRIPTION

Optical Mark Reading (OMR) systems generally include a sensor array 20 within a scanner 10. A form 30 for use with an OMR system has data columns arranged on the form so that data marks in these data columns will pass in front of sensor array 20 when card 30 is passed through scanner 10. Sensor array 20 measures the light reflecting from the surface of card 30 and evaluates the value measured against known values relating to the mark density. The data within the columns are further arranged to form rows which are parallel to scanner array 20 so that array 20 will measure the values for all locations within a single row at the same time. The values returned by the sensors for each row are sent to a software application on a host computer to which the scanner is attached for evaluation and analysis. The software application on the host computer compares the values within a given row with each other to determine the darkest mark perceived within the row. That value is then compared against a known table of values corresponding to the density or darkness of the mark to determine if the mark is dark enough to qualify as a valid mark. The column of the qualifying mark, if any, within each row in then sent to. For further information regarding the scanning and evaluation process, please see the co-pending and commonly owned application entitled Device and Method for Inspecting Markings, Attorney Docket No. 13674.6US01, which is incorporated herein by reference.

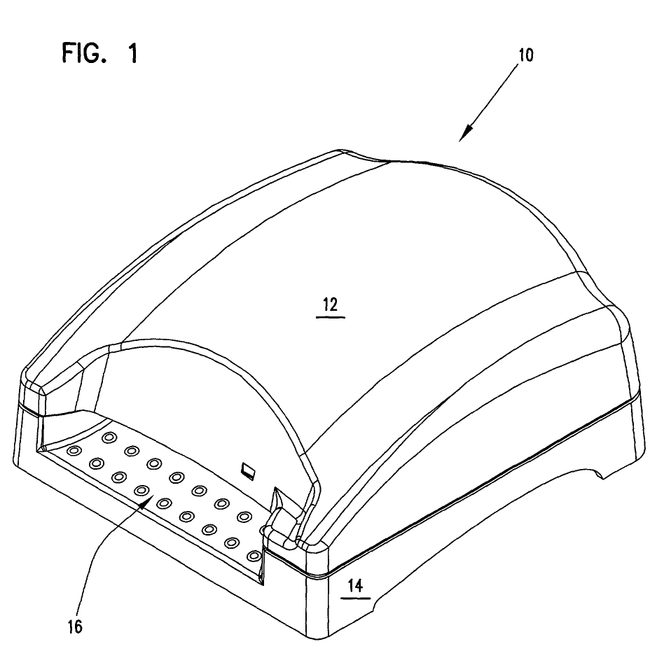

FIG. 1 shows a scanner 10 for use as part of an OMR system. Scanner 10 includes an upper scanning unit 12 and a base 14, which cooperate to form a path 16 through scanner 10 for form 30.

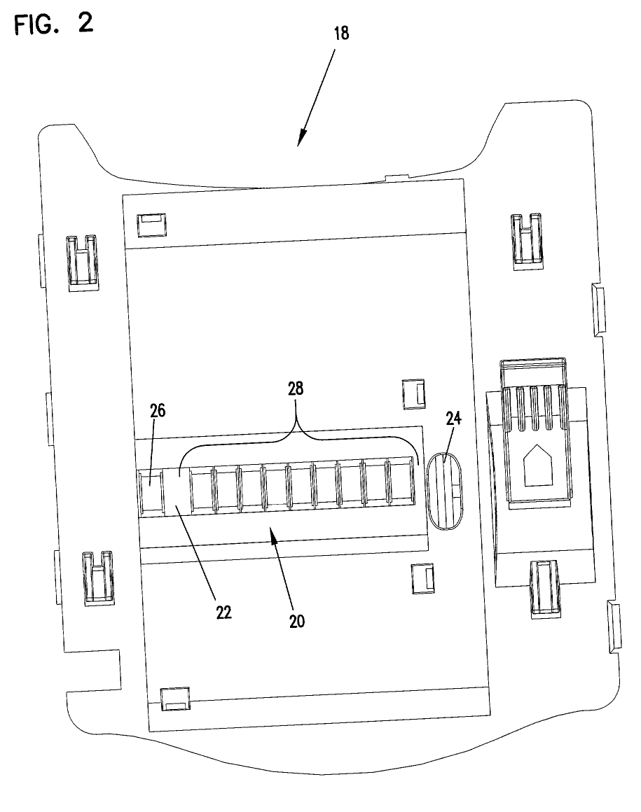

FIG. 2 shows a lower or scanning face of upper scanning unit 12. Upper scanning unit 12 contains a sensor array 20 and a drive mechanism 24 which draws a form 30 through scanner 10. Sensor array 20 is comprised often individual sensors. These sensors are arranged as shown, with sensor 26 on the opposite side of the array from drive mechanism 24 and a group 28 with nine sensors spaced apart from sensor 26 by a space 22. The size and purpose of this spacing will be discussed in more detail with respect to form 30 below. Alternative sensor arrays might include more or fewer sensors within group 28.

For further information regarding the scanner and drive mechanism, please see the co-pending and commonly owned application entitled Optical Mark Reader, Attorney Docket No. 13674.7US01, which is incorporated herein by reference.

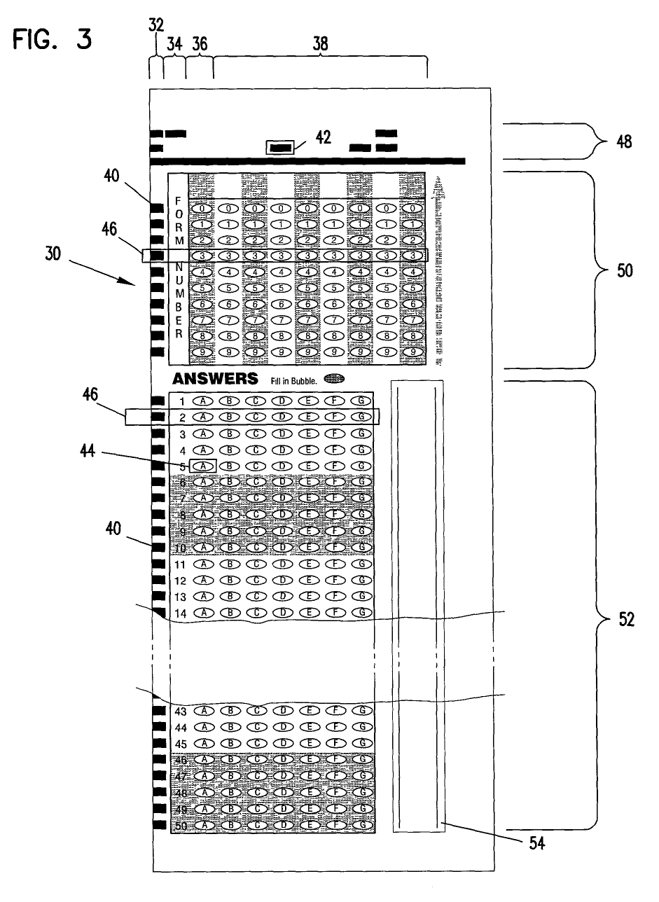

FIG. 3 shows a form 30 for use with scanner 10 as part of an OMR system. Form 30 comprises data organized into four general columns, each column being at least one data mark in width. A first column is timing mark column 32, which is one data mark wide. A second column is compatibility column 34, which is one data mark wide. A third column is calibration and data column 36, also one data mark wide. A fourth column is data column 38, which is eight data marks in width. Within timing mark column 32 are timing marks 40. Column 34, 36 and 38 include a plurality of data mark locations, which may be for pre-printed marks 42 or for bubbles 44 for user marking.

Each timing mark 40 designates a linearly arranged row 46 of data mark locations in each of the other columns. Rows 46 are grouped into three distinct areas: control and form data area 48, user information area 50, and response area 52. Within area 48, only pre-printed data marks 42 will appear, while columns 36 and 38 within areas 50 and 52 contain bubbles 44. In addition to the data marks on the form, an area 54 may also be designated for text or other information which is not to be scanned and evaluated by sensor array 20 of scanner 10.

Control and form data area 48 includes three rows 46 of pre-printed data marks 42. The presence or absence of the pre-printed data marks 42 within each of the columns 34, 36 and 38 in area 48 serves as graphical switches that may be sensed and acted upon by scanner 10. In the topmost row 46 within area 48, the data marks correspond to several specific details of the form 30 on which they are printed. A mark 42 in timing mark column 32 serves as a timing mark, which when sensed by sensor 26 triggers the recording of data from the remaining sensors 28. A mark 42 in compatibility column 34 in topmost row 46 of area 48 serves a backwards compatibility purpose that will be discussed in detail below.

A mark 42 in calibration and data column 36 within the topmost row 46 of area 48 serves as an initiator graphic switch for an on-board calibration routine of scanner 10. The absence or presence of a mark 42 in column 36 in this row 46 indicates to the firmware of scanner 10 that form 30 presently within scanner 10 is either a normal data card or is a specialized calibration card. In the illustrated embodiment, the absence of a data mark 42 in this location indicates that form 30 is not a calibration card.

The presence or absence of marks 42 within data column 38 of topmost row 46 of area 48 provides information regarding the type and length of form 30 to the firmware. This information may be used to allow the firmware of scanner 10 to perform several basic error detection routines. A form length of up to two hundred and fifty six rows may be signaled by the first row of data column 38. The second row 46 of area 48 contains data mark locations for receiving data marks 42 indicating different form styles or layouts, signaled by the use of binary encoding with marks 42 in the eight data mark locations within this row of column 38. Information encoded by marks within the remaining rows of area 48 can be used to identify other information that may be used by the firmware of scanner 10 or by other devices with which scanner 10 may communicate, such as a software application on a host computer. The third row in area 48 is a solid dark line crossing all data mark locations within the row. This row serves as a quality control row, to measure the values recorded by each sensor with respect to a mark of known density or darkness. If the values returned by the sensors relating to this row indicate inconsistency between the sensors, it may indicate that a re-calibration or other user action is desirable to ensure accurate reading of the form.

A mark 42 in compatibility column 34 on form 30 is not sensed by scanner 10, as column 34 will pass in front of space 22 in sensor array 20. The purpose of a mark in column 34 is to provide backwards compatibility with prior art OMR system scanners. Some prior art scanners have arrays of sensors which do not have a space 22 separating a timing mark sensor from the remaining sensors. A mark 42 within column 34 of topmost row 46 of area 48 could be used to signal an OMR system with one of these prior art scanners that form 30 is a new generation form. Such a data mark or graphic signal might be used to initiate software routines in these prior art systems for scoring and analyzing the data marks on form 30. The presence or absence of this graphic switch on form 30 would be invisible to scanner 10. Thus, a form 30 adapted for use with scanner 10 can also be backwards compatible with OMR systems with prior art scanners.

Due to the layout of sensors in scanner 10 and in some prior art OMR devices, compatibility column 34 of form 30 is of necessity adjacent to timing mark column 32. The relative location of calibration and data column 36 and data column 38 may be altered as desired on form 30, provided that each of the columns aligns with one of the sensors 28 when form 30 is inserted into path 16 of scanner 10. Within the present invention, it is possible to designate the presence or absence of a mark 42 in any row or column within area 48 as the graphic switch to initiate calibration. Columns 36 and 38 within area 48 can be moved relative to one another to create alternative forms which are in accordance with the present invention. Additionally, the rows within area 48 may be moved with respect to one another to create alternative forms which are in accordance with the present invention

Form 30 must include at least one surface as shown in FIG. 3. The opposite surface of form 30 may also be as shown in FIG. 3, provided the substrate on which form 30 is printed is such that data marks printed on one surface of the form 30 do not interfere with the sensing of data marks on the other side of form 30.

A method of using a form 30 may include a user providing a number of data marks in bubbles 44 within areas 50 and 52 on a form 30. An end of form 30 proximate control and form data area 48 is then inserted into path 16 of scanner 10. Form 30 engages drive mechanism 24 which moves from 30 past sensor array 20 so that timing mark column 32 is directly in front of sensor 26. When sensor 26 records the presence of a first timing mark within timing mark column 32, remaining sensors 28 begin recording data regarding the data marks within the first row 46 within area 48. As the drive mechanism moves form 30 further through path 16, each successive timing mark 40 in column 32 passes before sensor 26, indicating that the corresponding successive data mark row 46 is before sensors 28, and sensors 28 record data regarding the light reflecting from each of the data mark columns 34, 36 and 38 for that row 46.

Having described preferred aspects and embodiments of the present invention, modifications and equivalents of the disclosed concepts may readily occur to one skilled in the art. However, it is intended that such modifications and equivalents be included within the scope of the claims which are appended hereto.

What is claimed is as follows:

1. A data form for use with an optical mark reading apparatus that optically senses the presence of data marks on the form, the form comprising:
a sheet of material having at least one surface with a plurality of data mark locations thereon;
the data mark locations arranged in a plurality of transverse rows;
the data mark locations within the transverse rows arranged in a plurality of columns substantially perpendicular to the transverse rows, comprising a first column, a second column and a third column;
the first column comprising pre-printed timing marks in the data mark locations;
the second column including a data mark location for a form compatibility mark;
the third column including at least two rows of data mark locations with pre-printed data marks in data mark locations identifying the length and type of the form.

2. The data form of claim 1, wherein one of the pre-printed data marks within the third column identifies the form as a control form and initiates a calibration routine controlled by a firmware application on the optical mark reading apparatus, the results of the calibration routine being held within a data register on the optical mark reading apparatus.

3. A data form for use with an optical mark reading apparatus that optically senses the presence of data marks on the form, the form comprising:
a sheet of material having at least one surface with a plurality of data mark locations thereon, the surface having a top, a bottom, and a first side and a second parallel sides;
the data mark locations arranged in linear columns substantially parallel to the sides and further arranged in linear rows substantially perpendicular to the columns;
at least the two rows of data mark locations proximate the top designated control rows;
within the control rows, the columns of data marks arranged into a first column along the first side including timing marks in the data mark locations, a second column adjacent the first column including a form compatibility mark in one of the data mark locations, and a third column including at least one data mark in a data mark location identifying the layout of the remaining data mark locations on the form.

4. The data form of claim 3, the third column further including a data mark to initiate a scanner calibration function.

5. A data form for use with an optical mark reading apparatus that optically senses the presence of data marks on the form, the form comprising:
a sheet of material having at least one surface with a plurality of data mark locations thereon, the surface having a top, a bottom, and a first side and a second parallel sides;
the data mark locations arranged in linear columns substantially parallel to the sides and further arranged in linear rows substantially perpendicular to the columns;
at least the two rows of data mark locations proximate the top designated control rows;
within the control rows, the columns of data marks arranged into a first column along the first side including timing marks in the data mark locations, a second column adjacent the first column including a form compatibility mark in one of the data mark locations, and a third column including a data mark to initiate a scanner calibration function.

6. An optical mark reading system comprising a data form and a scanner;
the data form comprising:
a sheet of material having at least one surface with a plurality of data mark locations thereon;
the data mark locations arranged into a first column including timing marks in the data mark locations, a second column including a form compatibility mark in one of the data mark locations, and a third column including at least one data mark in a data mark location identifying the layout of the remaining data mark locations on the form;
the scanner including a path adapted to receive the data form and an array of sensors to optically scan the first and third columns for data marks in each of the data mark locations.

7. The optical mark reading system of claim 6, wherein the array of sensors scans the second column of data mark locations for data marks.

8. The optical mark scanning system of claim 6, wherein the third column includes a data mark to initiate a scanner calibration function.
